(19) United States
(12) Patent Application Publication
(10) Pub. No.: US 2025/0144787 A1
(43) Pub. Date: May 8, 2025

(54) PARALLEL LINK ROBOT

(71) Applicant: FANUC CORPORATION, Minamitsuru-gun, Yamanashi (JP)

(72) Inventor: Hyunchul SOUK, Yamanashi (JP)

(73) Assignee: FANUC CORPORATION, Minamitsuru-gun, Yamanashi (JP)

(21) Appl. No.: 18/838,227

(22) PCT Filed: Mar. 29, 2022
(86) PCT No.: PCT/JP2022/015424

§ 371 Date: Aug. 13, 2024

(51) Int. Cl. B25J 17/02; B25J 9/00

(52) U.S. Cl. CPC B25J 17/0216; B25J 9/0009

(57) ABSTRACT

A parallel link robot including a base portion, a movable portion, and arms which connect the base portion and the movable portion. Each of the arms includes a drive link rotationally driven about a predetermined axis line by a motor, two parallel driven links that forms a pair, and a connecting member that connects the driven links, each pair of driven links are coupled to the drive link by ball joints at a position where the drive link is positioned between the pair of driven links, the pair of driven links forms a joint together with the drive link, the connecting member includes a first portion both sides of which are attached to the pair of driven links, second portions which are arranged with a space in a direction of an interval between the pair of driven links, and a third portion connecting the first and second portions.

This application is a national phase of International Application No. PCT/JP2022/015424, filed Mar. 29, 2022,which is incorporated herein by reference in its entirety.

### TECHNICAL FIELD

The present disclosure relates to a parallel link robot.

### BACKGROUND ART

A known parallel link robot includes a base portion suspended from and fixed to a frame or the like, a movable portion disposed below the base portion, and three sets of link portions for connecting the base portion and the movable portion (for example, see PTL 1). Each of the link portions includes a drive link extending from the base portion, and two parallel driven links, which forms a pair, connected to both sides of a distal end of the drive link via ball joints.

Between the pair of driven links in PTL 1, two elongated plates are provided on both sides of the pair of driven links in order to maintain a constant distance between the driven links and to restrain the rotation of each driven link about the longitudinal axis. The elongated plate is attached to the driven links at a position sufficiently away from the ball joints to avoid interference with the drive link in a necessary operation range of the driven links with respect to the drive link.

### CITATION LIST

### Patent Literature

Japanese Unexamined Patent Application, Publication No. 2014-46406

### SUMMARY OF INVENTION

A first aspect of the present disclosure is a parallel link robot including: a base portion; a movable portion disposed below the base portion with a space; and a plurality of arms which connect, in parallel, the base portion and the movable portion, wherein each of the arms includes a drive link that is rotationally driven about a predetermined axis line by a motor provided in the base portion, two parallel driven links that forms a pair and that connect the drive link and the movable portion, and a connecting member that connects the driven links, each pair of driven links are coupled to the drive link by ball joints at a position where the drive link is positioned between the pair of driven links in the axial direction, the pair of driven links forms a joint together with the drive link, the connecting member includes a first portion both sides of which are attached to the pair of driven links on an outer side of the joint, second portions which are arranged with a space in a direction of an interval between the pair of driven links on an inner side of the joint, and a third portion connecting the first portion and the second portion.

### BRIEF DESCRIPTION OF DRAWINGS

FIG. 1 is a front view showing a schematic structure of a parallel link robot according to an embodiment of the present disclosure.

FIG. 2 is a schematic view showing a configuration of upper and lower joints of one of arms of the parallel link robot of FIG. 1.

FIG. 3 is a top surface view showing a configuration of an upper joint of one of the arms of the parallel link robot of FIG. 1.

FIG. 4 is a perspective view showing a connecting member of the parallel link robot of FIG. 1.

FIG. 5 is a schematic view of the arm of FIG. 2 with the connecting member detached from the upper joint.

FIG. 6 is a side view of the upper joint of the arm of FIG. 2.

FIG. 7 is a schematic view showing a configuration of an upper joint of one of the arms in a first modification of the parallel link robot of FIG. 1.

FIG. 8 is a schematic view showing a configuration of upper and lower joints of one of the arms in a second modification of the parallel link robot of FIG. 1.

FIG. 9 is a schematic view showing a configuration of upper and lower joints of one of the arms in a third modification of the parallel link robot of FIG. 1.

FIG. 10 is a top view showing a configuration of an upper joint of one of the arms in a fourth modification of the parallel link robot of FIG. 1.

FIG. 11 is a schematic view showing a configuration of upper and lower joints of one of the arms in a fifth modification of the parallel link robot of FIG. 1.

FIG. 12 is a bottom view showing a configuration of a lower joint of the arm shown in FIG. 11.

### DESCRIPTION OF EMBODIMENTS

It is conceivable that the ball joint may be detached due to deformation of the driven link which has the elongated plate as a fulcrum in the known parallel link robot.

Therefore, in the parallel link robot, it is desired to prevent the ball joint connecting the driven link and the drive link from being separated while ensuring a large operation range of the driven link with respect to the drive link.

A parallel link robot 1 according to an embodiment of the present disclosure will be described below with reference to the drawings.

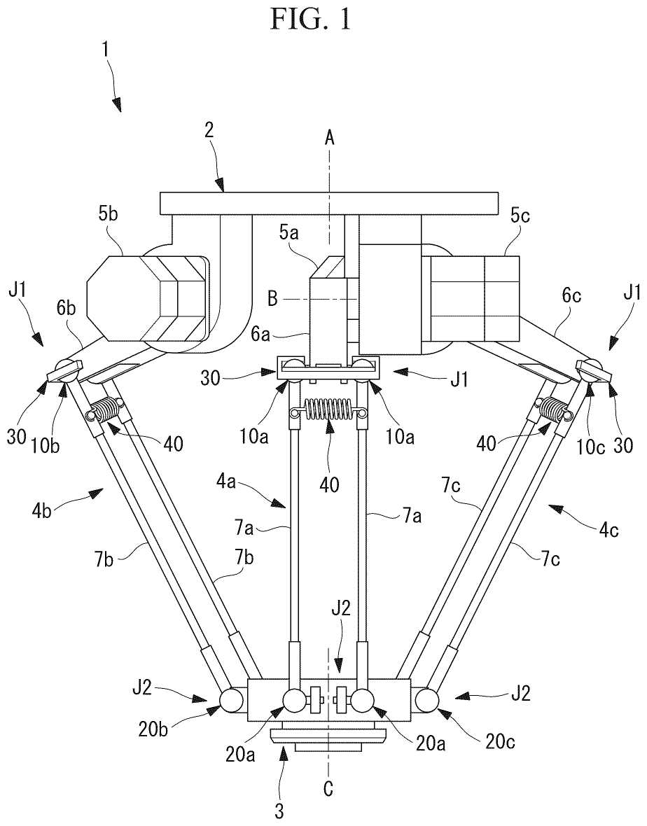

The parallel link robot 1 according to the present embodiment includes, for example, as shown in FIG. 1, a base portion 2 fixed by being suspended from a roof or the like, a movable part 3 disposed below the base portion 2 with a space, and three arms 4a, 4b, 4c connecting the base portion 2 and the movable part 3 in parallel.

Three servo motors (motors) 4a, 5b, 5c for driving the three arms 4a, 4b, 4c, respectively, are provided in the base portion 2. The servomotors 5a, 5b, 5c are arranged at equal intervals in the circumferential direction around an axis line A that passes through a center of the base portion 2 and extends in the vertical direction. Also, each of the servo motors 5a, 5b, 5c has a rotary drive shaft (not shown) that is rotated about a horizontal axis line B. The axis lines B of the servo motors 5a, 5b, 5c extend along the tangent direction of the same circle centered on the axis A.

The arms 4a, 4b, 4c have drive links 6a, 6b, 6c which are connected to the rotary drive shafts of the servo motors 5a, 5b, 5c so as to be driven to rotate about the axis line B. Also, each of the arms 4a, 4b, 4c includes two parallel rod-shaped (pair of) driven links 7a, 7b, 7c that connect the drive links 6a, 6b, 6c to the movable portion 3. Ball joints 10a, 10b, 10c and ball joint 20a, 20b, 20c are respectively provided at positions between the pair of driven links 7a, 7b, 7c and the drive links 6a, 6b, 6c and positions between the pair of driven links 7a, 7b, 7c and the movable portion 3.

Also, each pair of the driven links 7a, 7b, 7c includes a connecting member 30 for connecting the pair of driven links 7a, 7b, 7c with each other, and an biasing member 40 which connects each pair of driven links 7a, 7b, 7c and which generates force in a direction in which each pair of driven links 7a, 7b, 7c comes close.

Here, since the arms 4a, 4b, 4c have the same configuration, only the configuration of the arm 4a will be described below, and the description of the configuration of the arms 4b, 4c will be omitted.

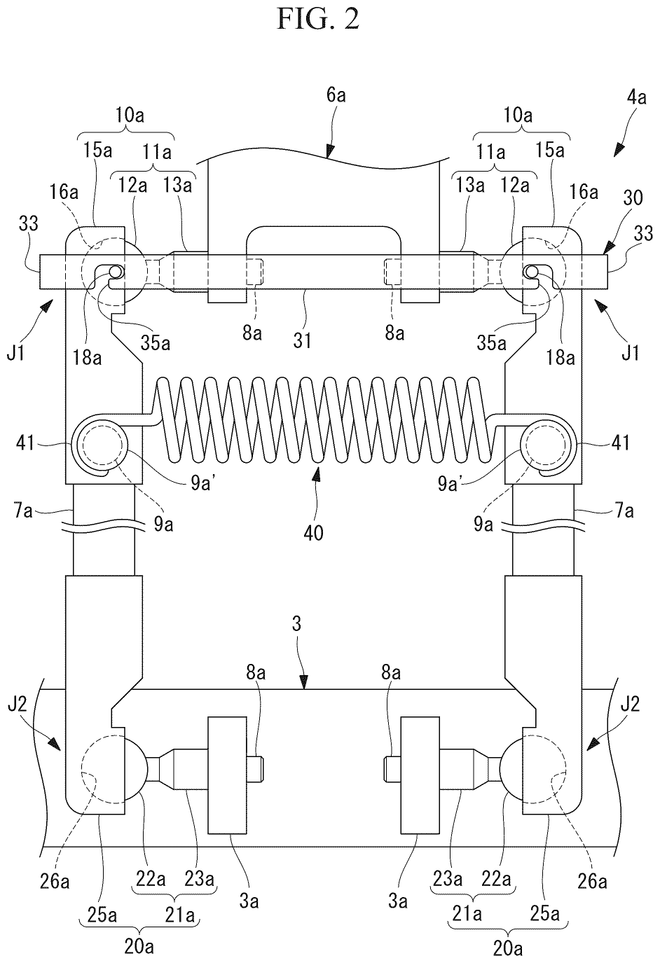

In the arm 4a, as shown in FIG. 2, one of the ends of the pair of driven links 7a are connected to the drive link 6a through the ball joints 10a so that the distal end of the drive link 6a is placed between the pair of driven links 7a in the axis line B direction (see FIG. 1). Also, the other ends of the pair of driven links 7a are connected, through the ball joints 20a, to side surfaces of wall-shaped attachment portions 3a projecting radially outwardly from the outer peripheral surface of the movable portion 3 in parallel with each other.

Each driven link 7a includes a socket 15a which is connected to one of the ends thereof in the longitudinal axis direction, and which constitutes a part of the ball joint 10a, which is described later, and a socket 25a which is connected to the other end thereof in the longitudinal axis direction, and which constitutes a part of the ball joint 20a, which is described later.

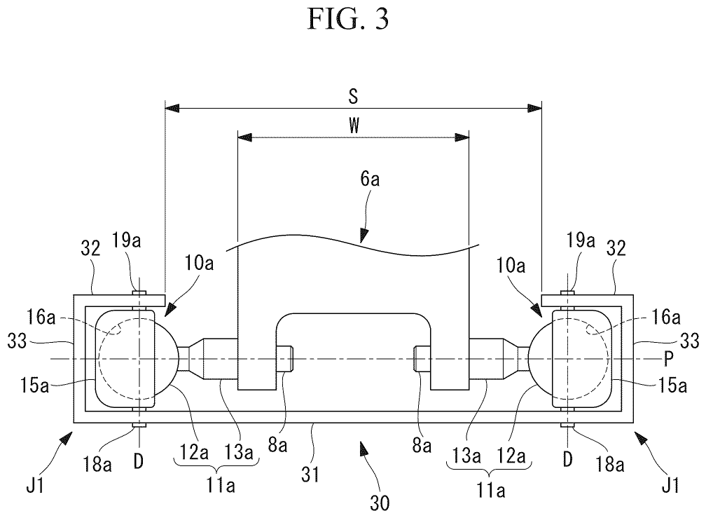

As shown in FIGS. 2 and 3, each of the ball joints 10a, 20a is composed of ball studs 11a, 21a and sockets 15a, 25a of the driven link 7a.

The ball studs 11a, 21a respectively includes balls 12a, 22a and studs 13a, 23a in a rod shape extending radially outwardly from an outer spherical surface of the balls 12a, 22a. The end surfaces of the pair of studs 13a are fixed to both sides between which the distal end of the drive link 6a is positioned in the direction of the axis line B by means of bolts 8a which are inserted from the inside of the distal end of the drive link 6a. Similarly, the end surfaces of the pair of studs 23a are fixed to the both sides between which the pair of attachment portions 3a is positioned in the direction of the axis B by means of the bolts 8a.

As shown in FIG. 2, the sockets 15a and the sockets 25a are provided with inner spherical surfaces 16a, 26a covering a half area of the outer spherical surface of balls 12a, 22a, respectively. Further, each of the balls 12a, 22a are supported so as to be rotatable around a center point by interposing a thin resin layer (not shown) made of a resin material such as silicone and the like in the inner spherical surfaces 16a, 26a. That is, by rotating the balls 12a, 22a around the center points within the inner spherical surfaces 16a, 26a of the sockets 15a, 25a, the studs 13a, 23a are tilted to an arbitrary angle. As a result, joints J1 and joints J2 are formed between the pair of driven links 7a and drive link 6a and between the pair of driven links 7a and movable portion 3.

As shown in FIGS. 2 and 3, first protrusions 18a and second protrusions 19a for attaching connecting member 30 are provided on the sockets 15a which are connected to one of the ends of the pair of driven links 7a. The first protrusions 18a and the second protrusions 19a are formed in a long and thin cylindrical shape, and protrude outward from the outer surface of the sockets 15a along an axis line (a center axis line) D passing through the center point of the inner spherical surface 16a in a direction orthogonal to a plan surface P including the longitudinal axes of the two driven links 7a.

That is, the first protrusions 18a protrude from the outer surface of the sockets 15a toward the outer side of the joint J1, and the second protrusions 19a protrude from the outer surface of the sockets 15a toward the inner side of the joint J1.

Each socket 15a is provided with a mounting pin 9a for supporting the biasing member 40. The mounting pin 9a is a cylindrical pin which protrudes from the outer surface of the socket 15a in the same direction as the first protrusion 18a, and which is arranged in parallel with the first protrusion 18a at a large interval in the radially outward direction. Each of the mounting pins 9a is provided with a flange 9a′ at the distal end of the mounting pin 9a, and the flange 9a′ has an outer diameter which is one level larger than that of the mounting pin 9a.

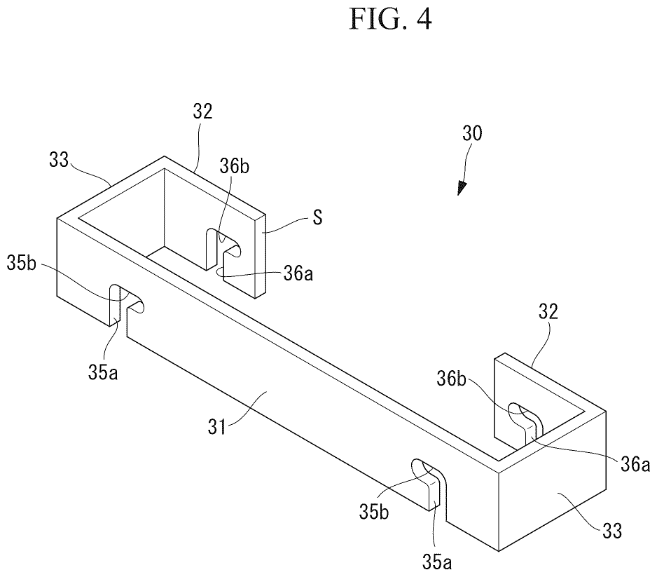

As shown in FIGS. 3 and 4, the connecting member 30 is formed in a frame shape partially having a notch by bending a metal strip plate having a predetermined width dimension by press working or the like. Thus, the connecting member 30 is provided with a flat and long first portion 31, two second portions 32 which are arranged parallel to the first portion 31 with a space, and two third portions 33 which connect the first portion 31 and the two second portions 32. The two second portions 32 are disposed on the same plan surface and are disposed with a space (a gap) S in the longitudinal direction of the first portion 31. As shown in FIG. 3, the space S is set to be larger than the width dimension W of the drive link 6a in the direction along the axis line B.

The first portion 31 is provided with two first through grooves (first mounting grooves) 35a penetrating in the plate thickness direction. Each first through groove 35a has a width dimension slightly larger than the outer diameter of the first protrusion 18a. Each first through groove 35a is formed in an L-shape having a room 35b extending in a direction approaching the other first through groove 35a along the longitudinal direction of the first portion 31 after extending straight from one end edge in the width direction of the first portion 31 to the center position in the width direction.

Similarly, each second portion 32 is provided with L-shaped second through grooves (second mounting grooves) 36 having a room 36b penetrating in the plate thickness direction at positions facing the first through grooves 35a. That is, the first through grooves 35a and the second through grooves 36a are formed in the same shape.

When the two ball joints 10a which are attached to the drive link 6a are arranged between the first portion 31 and the second portion 32 of the connecting member 30, the first protrusion 18a and the second protrusion 19a of the socket 15a penetrate the first through groove 35a and the second through groove 36a, respectively. As a result, the connecting member 30 is disposed at a position surrounding the two sockets 15a and the ball studs 11a.

As shown in FIG. 2, the dimension between the pair of first through grooves 35a and the dimension between the pair of second through grooves 36a at the one end edges of the first portion 31 and the second portions 32 of the connecting member 30 are set slightly larger than the distance between the centers of balls 12a of the pair of ball joints 10a. Therefore, when the connecting member 30 is attached to each sockets 15a, the first protrusions 18a and the second protrusions 19a penetrate the rooms 35b provided in the first through grooves 35a and the rooms 36b provided in the second through grooves 36a, respectively.

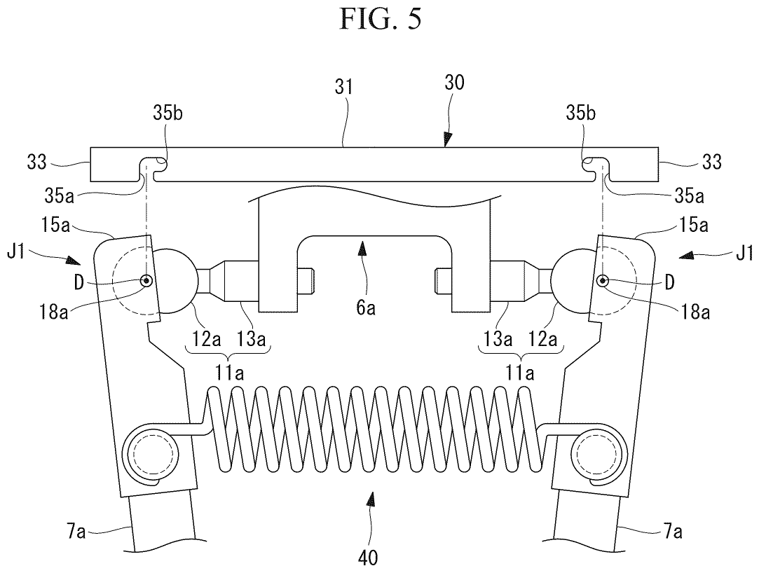

That is, in order to attach the connecting member 30 to the pair of sockets 15a, as shown in FIG. 5, a force is applied in a direction to increase the distance between the sockets 15a, and the distances between the first protrusions 18a and between the second protrusions 19a are made to correspond to the distances between the first through grooves 35a and between the second through grooves 36a, respectively. In this state, by bringing the connecting member 30 close to the first protrusions 18a and the second protrusions 19a in the radial direction, the first protrusions 18a and the second protrusions 19a are inserted into the first through grooves 35a and the second through grooves 36a, respectively. And, when the first protrusions 18a and the second protrusions 19a are inserted to the widthwise center position of the first portion 31 and the second portions 32, the force applied is released, whereby the first protrusions 18a and the second protrusions 19a are guided into the rooms 35b and the rooms 36b, respectively.

The biasing member 40 is an elastic member such as a coil spring and the like, for example, and both sides thereof is attached to the mounting pins 9a of the pair of sockets 15a. The biasing member 40 includes hooks 41 which are provided at both ends of the biasing member 40 so that the biasing member 40 is detachably attached to the pair of sockets 15a by hooking the hooks 41 to the mounting pins 9a of the respective sockets 15a. The hook 41 which is hooked on the mounting pin 9a is held by a flange portion 9a′ provided at the distal end of the mounting pin 9a so as not to be axially detached from the mounting pin 9a.

An operation of the parallel link robot 1 which is configured as described above will be described below. Also, in the following description, in order to make it easier to understand, each ball joint 10a, 10b, 10c is described by taking the ball joint 10a as an example, and the description of the ball joints 10b, 10c, which are the same as the boll joint 10a, is omitted. Similarly, the respective ball joints 20a, 20b, 20c will be described by taking the ball joint 20a as an example, and the description of the ball joints 20b, 20c, which are the same as the ball joint 20a, will be omitted.

According to the parallel link robot 1 of the present embodiment, when three servo motors 5a, 5b, 5c are driven in synchronization, each pair of the driven links 7a, 7b, 7c is passively swung with respect to each drive link 6a, 6b, 6c while maintaining a parallel relationship with each other. Thus, the movable portion 3 can be moved in translation by three degrees of freedom in two horizontal directions and one vertical direction, and can be positioned at a desired three dimensional position.

In this parallel link robot 1, for example, when the movable portion 3 is moved at high speed, a large inertial force acts on each arm 4a, 4b, 4c, particularly driven links 7a, 7b, 7c, and a force in a direction to increase the distance between the two driven links may act on each pair of driven links 7a, 7b, 7c.

In this case, since the pairs of sockets 15a are connected to each other by the connecting members 30, the distance between the pairs of sockets 15a is prevented from being greatly increased. This can prevent the sockets 15a from being separated from the balls 12a of the ball joint 10a, 10b, 10c between the driven links 7a, 7b, 7c and the drive links 6a, 6b, 6c.

For example, in the examples shown in FIGS. 2 and 3, the first protrusions 18a and the second protrusions 19a penetrate the first through grooves 35a and second through grooves 36a of the connecting member 30, respectively, on the axis line D passing through the center position of the balls 12a in the sockets 15a. Therefore, the distance between the first protrusions 18a and the second protrusions 19a does not become larger than the distance between the first through grooves 35a and the second through grooves 36a, and the distance between the sockets 15a is also maintained so as not to expand to a position where the sockets 15a are detached from the balls 12a.

As shown in FIG. 3, each pair of sockets 15a is pressed by the first portion 31 and the second portions 32 of connecting member 30 from the both sides of plan surface P including the both longitudinal axes of each driven links 7a, 7b, 7c. Therefore, even if the large inertial force acts on each pair of sockets 15a, each socket 15a can be prevented from being rotated around the longitudinal axes of the driven links 7a, 7b, 7c to which the sockets 15a are connected. Further, the relative displacement in the direction of twist between each pair of sockets 15a can also be regulated.

In this manner, each connecting member 30 is directly attached to a position surrounding each pair of the ball joints 10a, 10b, 10c connecting the driven links 7a, 7b, 7c and the drive links 6a, 6b, 6c. That is, since the pairs of sockets 15a are integrally connected to each other, the relative displacement between them can be reliably prevented, and separation of the ball joints 10a, 10b, 10c can be effectively suppressed.

Therefore, even when the large inertial force acts on each arm 4a, 4b, 4c, it is possible to prevent the driven links 7a, 7b, 7c from falling off from the drive links 6a, 6b, 6c.

Since the sockets 15a of each pair are always drawn inward in the direction of the interval by the biasing members 40, the inner spherical surfaces 16a are always pressed against the balls 12a. That is, even if the inertial force acts on each pair of the driven links 7a, 7b, 7c in the direction that increases the distance between the pair of driven links, the distance between each pair of the sockets 15a does not increase if the inertial force does not exceed the biasing force applied by the biasing member 40.

This configuration has an advantage that the possibility of separation of the pairs of ball joints 10a, 10b, 10c can further be reduced.

In addition, for example, when the movable portion 3 is moved upward by a large amount, the angles between the driving links 6a, 6b, 6c and the driven links 7a, 7b, 7c on the inner side of each joint J1 become small. That is, the second portion 32 of each connecting member 30 attached to the socket 15a at one of the ends of the driven links 7a, 7b, 7c is brought into proximity to the drive links 6a, 6b, 6c, respectively. In this case, the second portions 32 of each of the connecting members 30 are arranged with the space S larger than the width dimension W of each of the drive links 6a, 6b, 6c, as shown in FIG. 3.

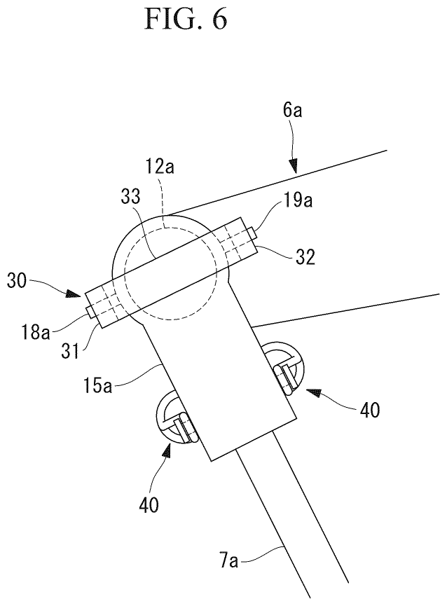

Therefore, even when the movable portion 3 is largely moved upward, as shown in FIG. 6, the drive links 6a, 6b, 6c are arranged in the space S between the second portions 32 of the respective connecting members 30, so that the interference between the respective connecting members 30 and drive links 6a, 6b, 6c can be avoided. As a result, even if each connecting member 30 is disposed at a position so that each connecting member 30 surrounds the center of the ball 12a of each of the ball joints 10a, 10b, 10c, the large operating range of the driven links 7a, 7b, 7c with respect to the drive links 6a, 6b, 6c can be secured.

Also, as shown in FIG. 2, the rooms 35b, 36b of the connecting member 30, which are in the state of being attached to the respective sockets 15a, extend toward a middle of the interval between the pair of sockets 15a and also extend beyond the center points of the inner spherical surfaces 16a. Therefore, even if the distance between the pair of sockets 15a, to which the connecting member 30 is attached, is reduced, the first protrusions 18a and the second protrusions 19a are maintained in a state where the protrusions penetrate the rooms 35b and rooms 36b, respectively.

Therefore, even if the resin layers of the ball joints 10a, 10b, 10c are worn and the interval between the pairs of sockets 15a is shortened by the biasing force applied by the biasing member 40, the connecting member 30 can allow the interval to change, and the attached state can be maintained.

Further, in this case, each connecting member 30 and each biasing member 40 are detachably attached to the arms 4a, 4b, 4c without using a fastening member such as a bolt, a screw, or the like. This also has an advantage that the assembly work at the time of manufacturing the present parallel link robot 1 and the disassembly work at the time of maintenance can be facilitated.

For example, in order to assemble the arm 4a, first, a pair of driven links 7a is brought close to the drive link 6a extending from the base portion 2 and the movable portion 3 arranged at a distance from the base portion 2 from both outer sides in the axis line B direction. Then, the inner spherical surface 16a of the socket 15a at one of the ends of each driven link 7a is fitted to the ball 12a of the ball stud 11a attached to the both side surfaces of the drive link 6a. Similarly, the inner spherical surface 26a of the socket 25a at the other end of each driven link 7a is fitted to the ball 22a of the ball stud 21a attached to the movable portion 3.

In this state, the hooks 41 provided at the both ends of the biasing member 40 are hooked on the mounting pins 9a provided on the pair of sockets 15a, whereby the biasing member 40 is attached to both sockets 15a, and the state of connection between the drive link 6a and movable portion 3 by the pair of driven links 7a is maintained.

Next, the drive link 6a is passed through the space S of the connecting member 30, and the drive link 6a is passed through the inside of the connecting member 30. In this state, the pair of driven links 7a is pulled in the direction against the biasing force applied by biasing member 40, and the distance between the sockets 15a at one of the ends of each driven link 7a is slightly increased. And, the distance between the first protrusions 18a and the second protrusions 19a provided on each socket 15a is made to match the distance between the pair of first through grooves 35a and the second through grooves 36a of each connecting member 30.

Thereafter, the one of the end sides of the first portions 31 and second portions 32 of the connecting member 30 is brought closer to the driven link 7a, and the first protrusions 18a and second protrusions 19a are passed through the first through grooves 35a and second through grooves 36a, respectively. After the respective first protrusions 18a and second protrusions 19a reach the depths of the respective first through grooves 35a and second through grooves 36a, the interval between the pair of driven links 7a is returned to the original distance.

As a result, the respective first protrusions 18a and the respective second protrusions 19a are introduced into the rooms 35b of the first through grooves 35a and the rooms 36b of the second through grooves 36a, respectively, and the connecting member 30 is attached to the pair of sockets 15a.

As described above, according to the present embodiment, the arms 4a, 4b, 4c can be easily assembled without using a tool, a dedicated jig, or the like. And, this facilitated assembly work makes it easier to assemble at a site. Therefore, in the transportation of the parallel link robot 1, the transportation can be performed in a state where each connecting members 30 and each biasing members 40 are separated from the arms 4a, 4b, 4c. As a result, as a transportation mode of the parallel link robot 1, instead of packing and transporting the whole parallel link robot 1 in an assembled state, it is possible to separate the robot into a unit including the base portion 2 to the drive link 6a, the three pairs of driven links 7a, and the movable portion 3. Accordingly, the respective components can be packaged more compactly, and improvement in transportation efficiency and reduction in transportation cost can be realized.

Also, in the present embodiment, the distance between the pair of first through grooves 35a and the distance between the pair of second through grooves 36a at one of the end edges of the first portion 31 and the second portions 32 of the connecting member 30 are set larger than the distance between the first protrusions 18a and the distance between the second protrusions 19a, respectively. Alternatively, the distance between the pair of first through grooves 35a and the distance between second through grooves 36a at one of the end edges of the first portion 31 and second portions 32 of the connecting member 30 may correspond to the space between first protrusions 18a and the space between second protrusions 19a, respectively.

In this case, when attaching and detaching the connecting member 30 to and from each pair of the sockets 15a, it is not necessary to increase the distance between each pair of the sockets 15a, and it is sufficient to simply move the connecting member 30 along the direction in which the first through grooves 35a and second through grooves 36a extend. Therefore, the attaching and detaching operation of the arms 4a, 4b, 4c with respect to the connecting member 30 can be made more easily.

In addition, in the present embodiment, the inner spherical surface 16a of each socket 15a covers the half area of the outer spherical surface of each ball 12a, however, instead of this, the inner spherical surface 16a may cover an area which is smaller than the half of the outer spherical surface of each ball 12a.

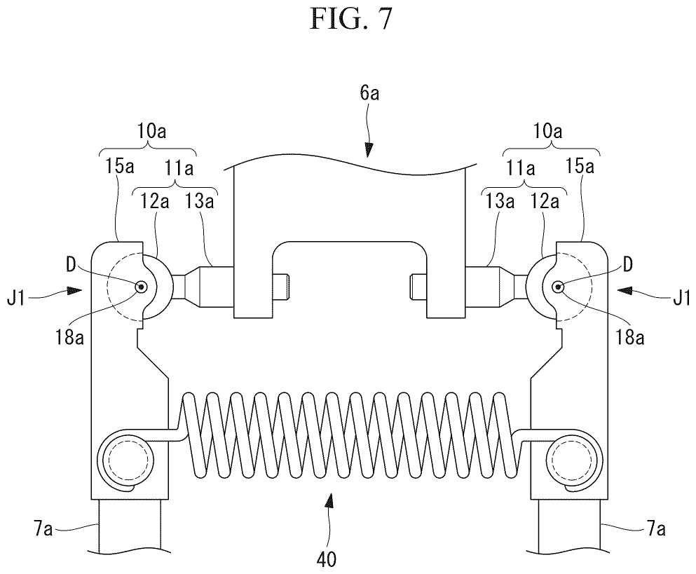

In this case, as shown in FIG. 7, only a part of the outer surface of each socket 15a is projected inward in the direction of the interval between the pair of driven links 7a, 7b, 7c. As a result, the first protrusions 18a and the second protrusions 19a can be arranged on the axis line D passing through the center point of the ball 12a.

This allows the size of the socket 15a to be minimized while allowing each connecting member 30 to follow the rotational movement of the ball joints 10a, 10b, 10c.

Also, in the present embodiment, the first through grooves 35a and the second through grooves 36a on both sides of the connecting member 30 are provided with the rooms 35b and the rooms 36b, respectively. Alternatively, the first through grooves 35a or the second through grooves 36a may have the room 35b or the room 36b. Further, when there is a little possibility of wear of the resin layer of each ball joint 10a, 10b, 10c, the room 35b and the room 36b may be omitted.

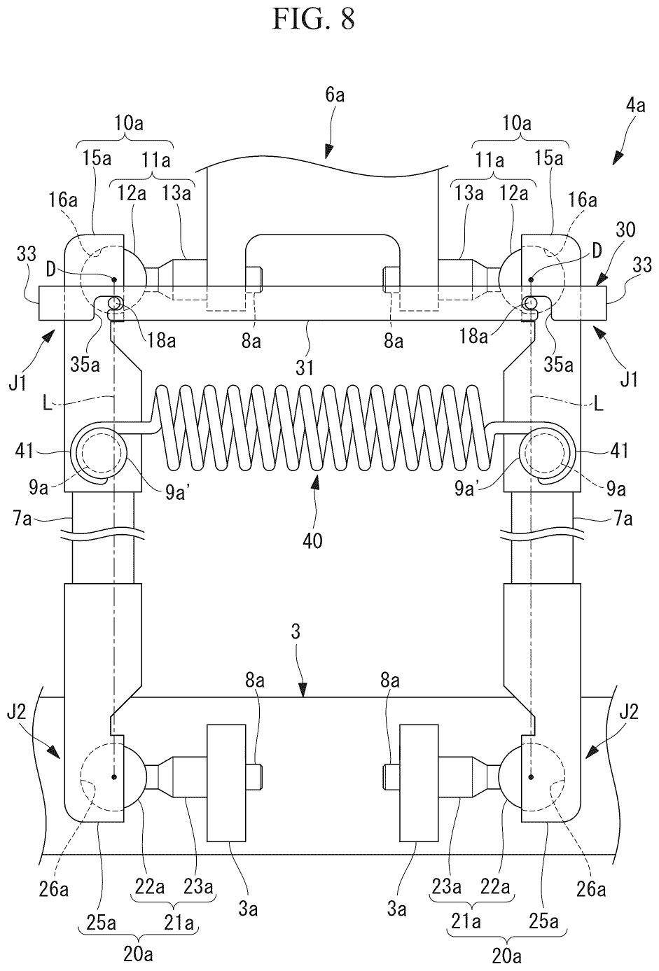

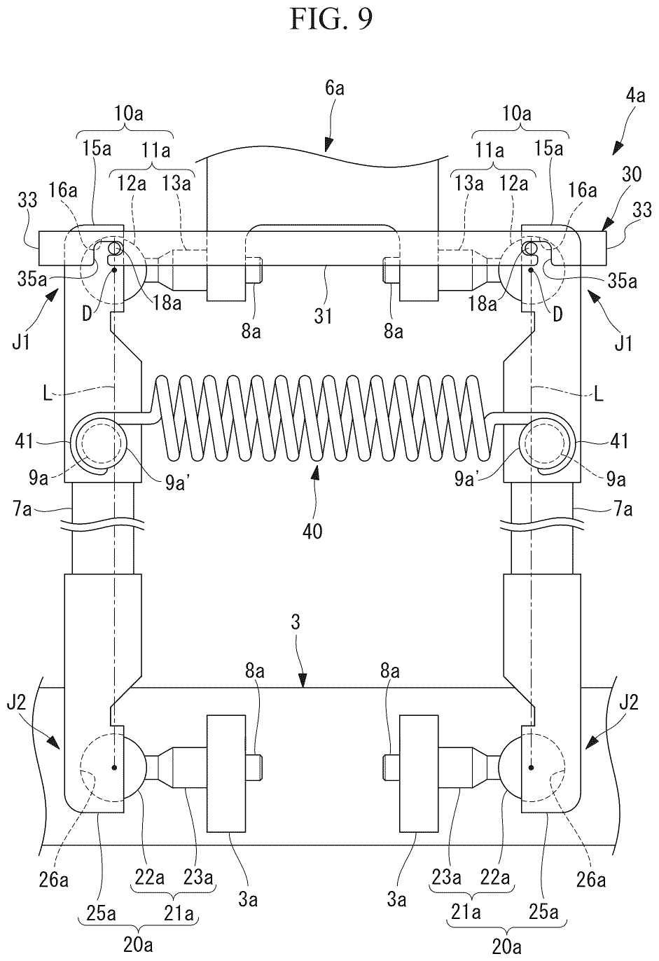

Also, in the present embodiment, each of the first protrusions 18a and the second protrusions 19a are disposed on the axis line D passing through the center point of the ball 12a in a state where the balls 12a of the ball joints 10a, 10b, and 10c are accommodated in the sockets 15a. Alternatively, as shown in FIG. 8, the first protrusions 18a and the second protrusions 19a may be disposed at positions deviated in the direction close to the ball studs 21a from the axis line D on the straight line L connecting the ball studs 11a and 21a. Alternatively, as shown in FIG. 9, the first protrusions 18a and the second protrusions 19a may be disposed at positions deviated in the direction away from the ball studs 21a from the axis line D on the straight line L connecting the ball studs 11a and 21a.

In this case, the amount of deviation of the first protrusions 18a and the second protrusions 19a from the axis line D is within a range in which the connecting member 30 is disposed at a position where the connecting member 30 surrounds at least a part of the pair of sockets 15a and the ball studs 11a. This makes it possible to obtain an effect which is the same as or similar to the above effect.

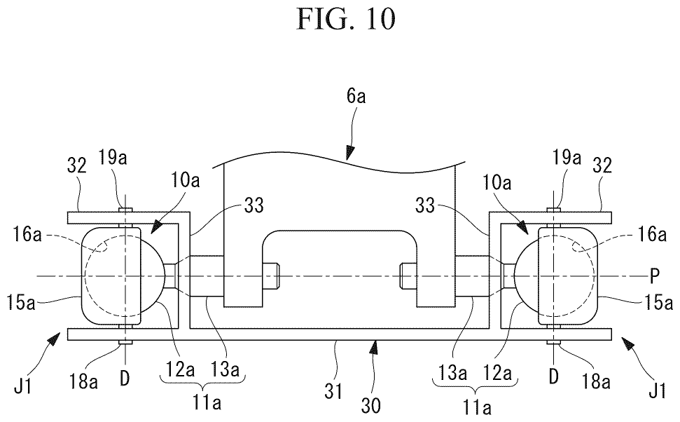

In addition, in the present embodiment, the case where the third portion 33 is disposed outside the socket 15a has been described as an example, but instead, when the first protrusion 18a and second protrusion 19a are disposed at a position deviated from the axis D of the ball 12a as shown in FIG. 8 or 9, the first portion 31 and the second portions 32 may be connected at a position located between the pair of sockets 15a as shown in FIG. 10.

In the present embodiment, the connecting member 30 and the biasing member 40 are attached only to the ball joints 10a, 10b, 10c for connecting the driven links 7a, 7b, 7c and the drive links 6a, 6b, 6c. In addition, the connecting member 30 and the biasing member 40 may be attached for the ball joints 20a, 20b, 20c that connect the driven links 7a, 7b, 7c and the movable portion 3.

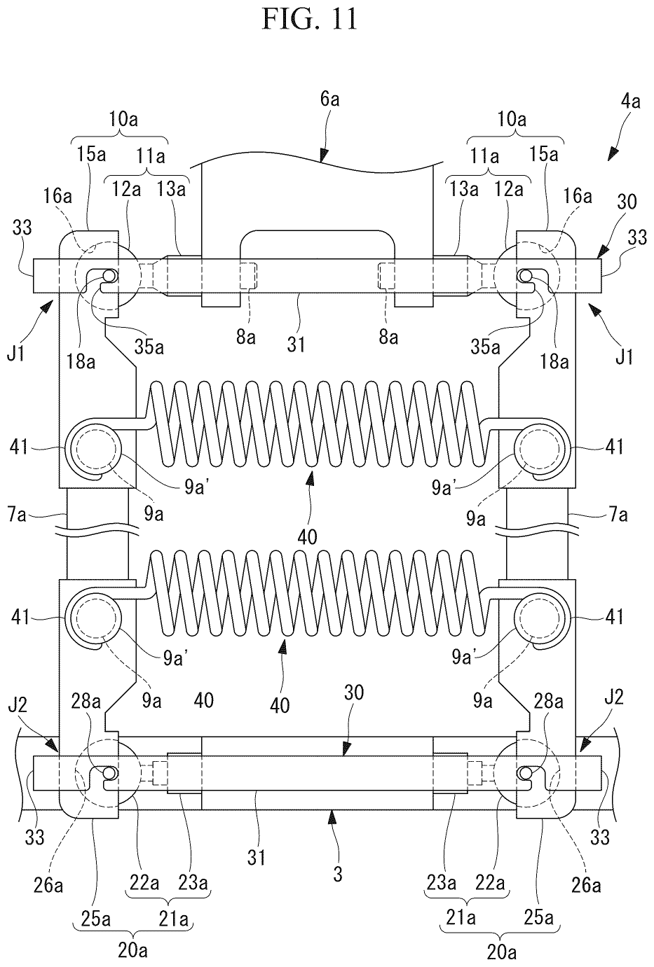

For example, when the dimensions of the driven links 7a, 7b, 7c in the longitudinal axis direction are relatively long, the biasing member 40 can be attached not only to the pair of sockets 15a but also to the pair of sockets 25a as shown in FIG. 11. In this case, each socket 25a may be provided with a mounting pin 9a which is similar to that of the socket 15a.

Thus, the pair of sockets 25a is strongly pressed against the balls 22a by the biasing members 40 provided over the pair of sockets 25a, and each socket 25a can be made more difficult to be separated from the balls 22a.

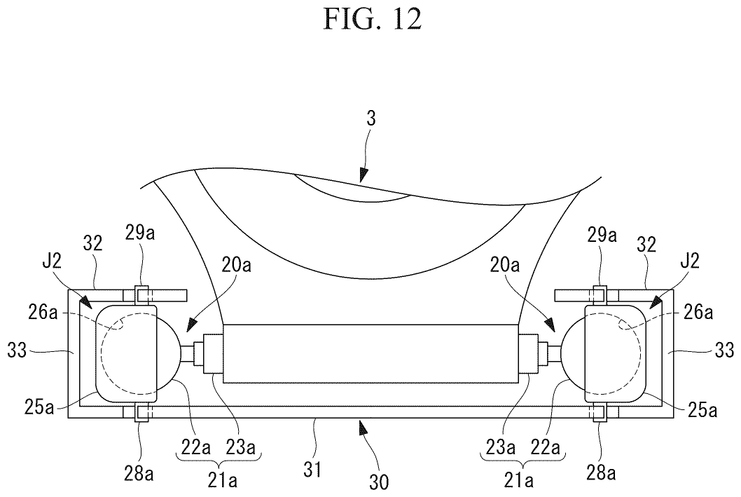

Furthermore, as shown in FIG. 12, when the outer peripheral surface of the movable portion 3 has a shape in which a part of the outer peripheral surface protrudes outward in the radial direction and the ball joints 20a are disposed on the both sides of the protruding part, the connecting member 30 can be attached to the pair of sockets 25a. In this case, it is sufficient that the socket 25a is provided with first protrusions 28a and second protrusions 29a protruding toward the outer side and the inner side of a joint J2 along the axis line passing through the center point of the inner spherical surface 26a of the socket 25a, as in the case of the socket 15a.

As a result, as in the case of the joint J1, the joint J2 can also more reliably prevent the separation of the ball joints 20a, 20b, 20c while maintaining the large movable range of the driven links 7a, 7b, 7c with respect to the movable portion 3.

In the present embodiment, the connecting member 30 is provided with the first through grooves 35a and the second through grooves 36a formed by penetrating the first portion 31 and second portions 32 in the plate thickness direction, as the mounting grooves for mounting to the pair of sockets 15a. Alternatively, in order to attach the connecting member 30 to the pair of sockets 15a, the first attachment grooves 35a and the second attachment grooves 36a provided in the connecting member 30 may be formed by carving the connecting member to a depth within a range not exceeding the plate thickness of the first portion 31 and the second portions 32, respectively.

1. A parallel link robot comprising:
a base portion;
a movable portion disposed below the base portion with a space; and
a plurality of arms which connect, in parallel, the base portion and the movable portion, wherein
each of the arms includes a drive link that is rotationally driven about a predetermined axis line by a motor provided in the base portion, two parallel driven links that form a pair and that connect the drive link and the movable portion, and a connecting member that connects the driven links,
each pair of driven links are coupled to the drive link by ball joints at a position where the drive link is positioned between the pair of driven links in the axial direction, the pair of driven links forms a joint together with the drive link,
the connecting member includes a first portion both sides of which are attached to the pair of driven links on an outer side of the joint, second portions which are arranged with a space in a direction of an interval between the pair of driven links on an inner side of the joint, and a third portion connecting the first portion and the second portion.

2. The parallel link robot according to claim 1, further comprising a biasing member both sides of which are attached to each pair of driven links and which is spaced from the drive link, the biasing member biasing the pair of the driven links in a direction in which the driven links are brought closer to each other.

3. The parallel link robot according to claim 1, wherein
each of the driven links has a first protrusion protruding toward the outer side from the joint and supporting the first portion, and a second protrusion protruding toward the inner side from the joint and supporting the second portion,
the first protrusions and the second protrusions are perpendicular to a plan surface including longitudinal axes of the pair of driven links and extend in a direction along a center axis line passing through a rotation center of each ball joint,
the connecting member includes a pair of first mounting grooves provided in the first portion and accommodating the first protrusions, respectively, and a pair of second mounting grooves provided in the second portion and accommodating the second protrusions, respectively,
each of the first mounting grooves and each of the second mounting grooves are formed to allow the first protrusion and the second protrusion to be inserted from an end edge of the first portion and an end edge of the second portion.

4. The parallel link robot according to claim 3, wherein
the first portion and the second portion are formed in a plate shape,
the first mounting grooves are formed to penetrate the first portion in a plate thickness direction, and
the second mounting grooves are formed to penetrate the second portions in a plate thickness direction.

5. The parallel link robot according to claim 3, wherein at least one of the first mounting grooves and at least one of the second mounting grooves, which are located at one side of the connecting member in the direction of the interval, respectively have a room extending toward an inner side of the interval, wherein the room allows the first protrusion or the second protrusion to be inserted.

6. The parallel link robot according to claim 5, wherein
a distance between the pair of first mounting grooves and a distance between the pair of second mounting grooves are greater than a distance between the center axis lines of the pair of ball joints.
